(19) United States
(12) Patent Application Publication
(10) Pub. No.: US 2009/0214363 A1
(43) Pub. Date: Aug. 27, 2009

(54) MOTOR AND COMPRESSOR INCLUDING THE SAME

(75) Inventors: Taeyoung NOH, Tianjin (CN); Sungdae KIM, Tianjin (CN); Tianming ZHOU, Tianjin (CN); Tieliang SUN, Tianjin (CN); Jianxun YU, Tianjin (CN); Shoujing ZHANG, Tianjin (CN)

Correspondence Address: MATTHIAS SCHOLL, 14781 MEMORIAL DRIVE, SUITE 1319, HOUSTON, TX, 77079, US

(73) Assignee: LG ELECTRONICS TIANJIN APPLIANCES CO., LTD., Tianjin (CN)

(21) Appl. No.: 12/437,777

(22) Filed: May 8, 2009

Related U.S. Application Data
(63) Continuation of application No. PCT/CN2007/003053, filed on Oct. 26, 2007.

(30) Foreign Application Priority Data
Nov. 10, 2006 (CN) 200610129329.3

(51) Int. Cl. F04B 17/03; H02K 23/36

(52) U.S. Cl. 417/423.7; 310/198

(57) ABSTRACT

A motor and a compressor including the same. The motor includes a rotor (120) and a stator (110). Stator coils are wound around the stator (110). The stator coils include a main coil (112) and a sub coil (114) formed of material having a different conductivity from the main coil. A compressor for compressing fluid includes the motor.

### CROSS-REFERENCE TO RELATED APPLICATIONS

This application is a continuation of International Patent Application No. PCT/CN2007/003053 with an international filing date of Oct. 26, 2007, designating the United States, now pending, and further claims priority benefits to Chinese Patent Application No. 200610129329.3 filed Nov. 10, 2006. The contents of all of the aforementioned applications, including any intervening amendments thereto, are incorporated herein by reference.

### BACKGROUND OF THE INVENTION

1. Field of the Invention

The present invention relates to a motor. More particularly, the present invention relates to a motor of which material cost is reduced to reduce overall production cost.

2. Background Art

A motor typically transmits a rotational force of a rotor to a rotational shaft and the rotational shaft drives load. For example, the rotational shaft may be connected to a drum of a laundry machine to drive the drum or the rotational shaft may be connected to a fan of a refrigerator to drive the fan to supply cool air to a predetermined space.

Such motors may be applicable to compressors that compress fluid, especially, refrigerant. Generally, compressors may be categorized into rotation-type compressors, reciprocation-type compressors and linear-type compressors. Here, a rotation-type compressor adapts a rotational motor and a linear-type compressor adapts a linear motor.

In a view of a volume rate or material cost, the motors take important roles in such compressors, compared to other electric appliances. In addition, the ratio of a motor weight to an overall weight of a compressor is relatively higher than the ratio of each weight of the other elements. As a result, the matter of motor volume and motor weight cannot but be relatively important in the compressor.

In such a rotational motor, a rotor is rotated by an electromagnetic interaction with a stator. For that, a stator coil is wound around the stator and the rotor is rotated with respect to the stator as an electric current is applied to the coil.

The coil is commonly formed of copper. Since copper has good conductivity and flexibility, there is less damage in winding the copper coil.

### DISCLOSURE OF INVENTION

Technical Problem

However, copper costs relatively a lot and thus production cost of a motor is increased. Because of such high production cost of motors, production cost of compressors that adapt such a motor is high.

In addition, normal supply-demand of raw material might not be performed because of a sudden rise of international copper demand. This could be quite a big problem based on the premise that motors should be mass-produced securely.

As a result, there would be necessity of a coil formed of other materials rather than copper to reduce the manufacturing cost of motors as well as to make supply-demand of raw material secure. Although the coil formed of other materials is used, a motor having a satisfactory performance have to be presented in comparison of using the conventional copper coil.

If the coil formed of other materials is replaced with the copper coil, it is preferable that the conventional structure of the motor is not changed a lot. Even though the manufacturing cost of the coil is reduced, new and additional structural elements should be designed and manufactured. As a result, an early investment in plant and equipment for the new structure might be increased too much.

Technical Solution

To solve the problems, an object of the present invention is to provide a motor including a stator coil of which material cost is reduced to reduce overall production cost.

Another object of the present invention is to provide a motor has a satisfactory capacity without any changed of its configuration with the reduced material cost of the stator coil, compared to the conventional motors.

A further object of the present invention is to provide a motor or compressor which may be produced in large quantities.

To achieve these objects and other advantages and in accordance with the purpose of the invention, as embodied and broadly described herein, a motor includes a rotor; and a stator that a stator coil is wound around, the stator coil including a main coil and a sub coil formed of material having a different conductivity from the main coil.

Here, a conductive material of at least one of the main coil and the sub coil may be configured of aluminum or aluminum alloy.

A conductive material of at least one of the main coil and the sub coil may be configured of copper. A conductive material of at least one of the main coil and the sub coil may be configured of aluminum alloy or copper claded aluminum.

A conductive material of the main coil may be configured of copper and a conductive material of the sub coil may be configured of aluminum alloy or copper claded aluminum. In this case, a diameter of the main coil is different from a diameter of the sub coil. It is preferable that the diameter of the coil having a lower conductivity is larger.

It is preferable that a width of an opening of a stator slot having the sub coil wound in is substantially larger than a width of an opening of a stator slot having the main coil wound in. also, it is preferable that a cross-section of a stator slot having the sub coil wound in is identical to or larger than a cross-section of a stator slot having the main coil wound in.

In another aspect of the present invention, a motor includes a rotor; and a stator that a stator coil is wound around, the stator coil including a first main coil, and a second main coil connected with the first main coil in serial and separated from the first main coil, the second main coil formed of a material having a different conductivity from the first main coil.

In a further aspect of the present invention, a compressor including a motor operated to compress fluid, wherein the motor includes a rotor; and a stator that a stator coil is wound around, the stator coil comprising a main coil, and a sub coil formed of material having a different conductivity from the main coil.

Here, it is preferable that a diameter of the main coil is different from a diameter of the sub coil.

Advantageous Effects

The present invention has following advantageous effects.

The present invention has an advantageous effect that an economical motor can be provided by reducing a material cost of coils.

Furthermore, the present invention has another advantageous effect that motors and compressors can be produced in large quantities without any change of their configurations, with the reduced material cost.

A still further, the present invention has a still further advantageous effect that a motor and a compressor having a satisfactory capacity, compared to the conventional one can be provided.

### BRIEF DESCRIPTION OF THE DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a sectional view illustrating a rotor and stator provided in a motor according to the present invention;

FIG. 2 is a diagram schematically illustrating the rotor and a stator coil shown in FIG. 1;

FIG. 3 is a perspective view illustrating the stator of FIG. 1;

FIG. 4 is a table illustrating comparison of an energy efficiency ratio of the motor according to the present invention;

FIG. 5 is a graph illustrating comparison of raw material cost of the motor according to the present invention;

FIG. 6 is a circuit view illustrating another embodiment of the motor according to the present invention; and

FIG. 7 is a sectional view illustrating a compressor according to the present invention.

### BEST MODE

Reference will now be made in detail to the specific embodiments of the present invention, examples of which are illustrated in the accompanying drawings. Wherever possible, the same reference numbers will be used throughout the drawings to refer to the same or like parts.

A plurality of stator coils may be wound around a stator in a motor according to the present invention. That is, the motor includes the plurality of stator coils connected in serial or parallel. For example, the motor may be an induction motor.

In a single phase induction motor, a main coil and a sub coil are wound around a stator and the main coil is away from the sub coil at 90° C. of a spacious electrical angle. Here, the power is directly applied to the main coil and applied to the sub coil via a capacitor and a switch, because the motor is not operated by applying the power only to the main coil. A rotating field is created at the stator via an operational unit such as the sub coil to operate the rotor.

Such the operational unit may be classified into a split-phase start type, shading coil start type, capacitor start type or repulsion start type.

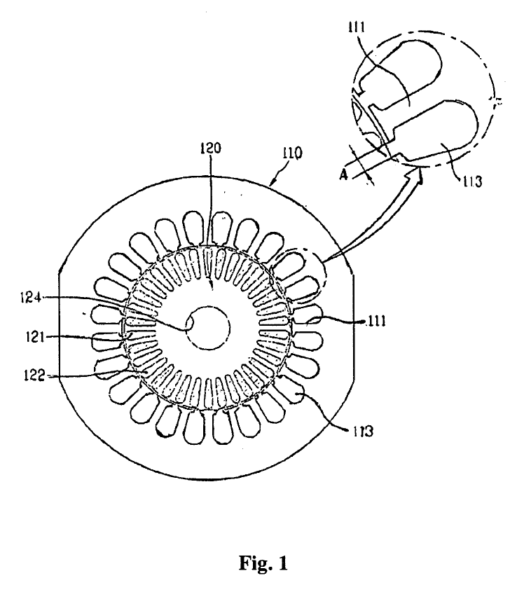

A capacity start type single phase induction motor is shown in FIGS. 1 to 3 as an example of such the single phase induction motor including such operational units.

If only main coil 112 is wound around a stator 110, only an alternating magnetic field is created at the stator 110 and a rotor 120 is not operated. As a result, a sub coil 114 is wound around the stator 110 to generate a rotating magnetic field and the rotor 120 is rotated in a predetermined direction by the rotating magnetic field, which means that an operational torque is generated by the rotating magnetic field.

Here, a capacitor 115 delays a phase of an electric current applied to the sub coil 114 to generate the operational torque through a mutual relative action with the main coil 112. Once being rotated, the rotor 120 maintains its rotation even without the power applied to the sub coil 114, unless there is no change of load. In case of more than a predetermined rotation number after the rotation of the rotor, the power does not have to be applied to the sub coil 114. However, if there are changes of load, the operational torque is needed and thus it is preferable that the sub coil 114 is provided with the power via the capacitor 115.

Of course, in case of a three-phase induction motor, only the main coil is wound around the stator and the rotating magnetic field is generated. As a result, the above sub coil does not have to be wound around the stator, which means that such an auxiliary operational unit is not necessary.

Such above single phase induction motor need not have an inverter configuration such as a BLDC (Brushless DC) motor or reluctant motor and it uses the single phase power to be operated, which results in good price competitiveness.

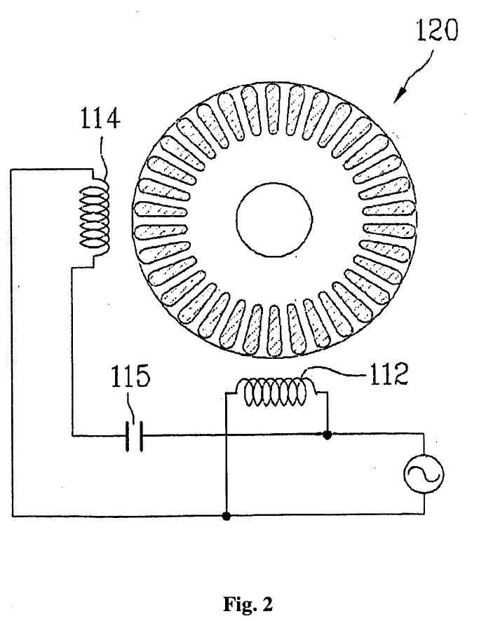

In reference to FIGS. 1 and 2, the motor according to the present invention, especially, a single phase induction motor will be explained in detail.

The stator 110 is hollow and it includes a plurality of teeth 111 and the main coil 112. The plurality of teeth 111 may be arranged in a predetermined distance along an inner circumferential surface of the stator 110 and they are projected inward in a radial direction. The main coil 112 is wound around each tooth 111 for each tooth 111 to have S pole or N pole when a first electric current is applied.

Here, an insulator (not shown) is provided between the teeth 111 and the main coil 112 to perform insulation between the teeth 111 and the main coil 112 and to allow the main coil 112 wound smoothly.

In addition, the stator 110 includes a sub coil 114 wound away from the main coil 112 at a spacious electrical angle to form a rotating magnetic field when an electric current is applied. Here, the sub coil 114 is also wound around each tooth 111 through the insulator (not shown). The main coil 112 and the sub coil 114 will be configured as a stator coil or a coil.

The coil 112 and 114 is connected with a single phase power. The main coil 112 and the sub coil 114 are connected each other in parallel and the sub coil 114 is connected with the capacitor 115 in serial.

Although not shown in the drawings, the capacitor 115 may be selectively connected with the power through a switch.

On the other hand, the main coil 112 and the sub coil 114 may be wound around the stator 110 in various ways. For example, the main coil 112 and the sub coil 114 may be wound in a concentration type so that a single tooth 111 forms a single pole, or the main coil 112 and the sub coil 114 may be wound in a dispersion type so that plural teeth 111 form a single pole. Commonly, the coil is wound in the dispersion type in an inner rotor type motor having a rotor rotatable in a stator and the coil is wound in the concentration type in an outer rotor type motor having a rotor rotatable out of a stator.

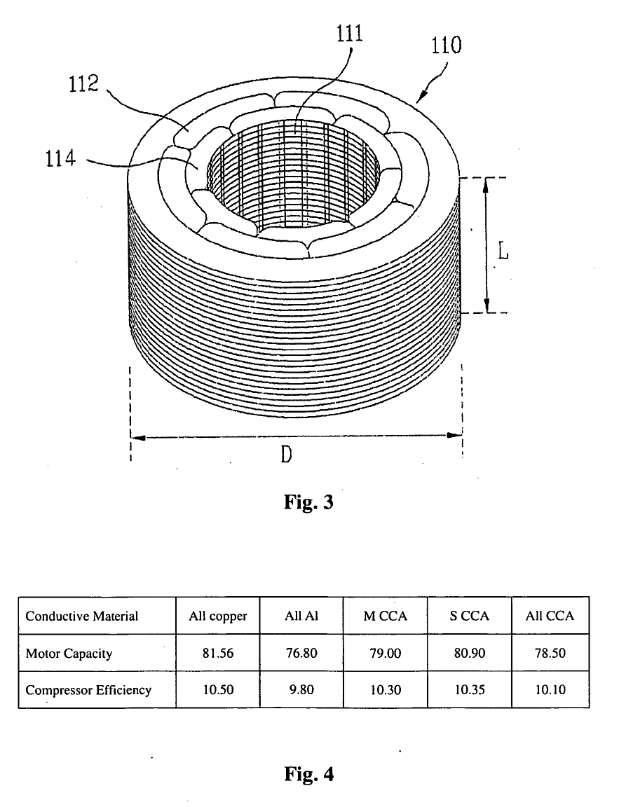

FIG. 3 shows that the main coil 112 and the sub coil 114 are wound around the plurality of teeth 111 to form six N poles and six S poles. Here, a predetermined space formed between each two neighboring teeth 111 is called a slot 113 and thus it can be said that the stator coil is wound between one slot and a neighboring slot. In the stator shown in FIG. 3, the coil is not wound in every slot and the main coil is wound in predetermined slots and the sub coil 14 is wound in another predetermined slots.

Typically, a squirrel cage rotor is used a lot as the rotor 120 and such a squirrel case rotor is shown in FIGS. 1 and 2.

Such the rotor 120 is formed by multi-layering steel plates having a plurality of slots 121. The plurality of the slots 121 are arranged at a predetermined radial position along an outer circumference at a predetermined angle from a center. The rotor 120 includes a conductor bar 122 inserted in the slot 121 of the rotor core. The conductor bar 122 is configured of a copper or aluminum bar.

Through the conductor bar 122, both opposite ends of the squirrel case rotor forms endrings and the endrings are formed by aluminum die casting. Specifically, the conductor bar 122 and the endrings are formed as one body by the aluminum die casting and endrings are formed at an upper and lower portion of the rotor core, respectively.

In the meantime, a shaft hole 124 is formed at the rotor 120. A rotational shaft (not shown) is inserted in the shaft hole 124 to transmit a rotational force of the rotor 120 outside and the rotor 120 is rotated together with the rotational shaft. The rotational shaft supplies the power needed to compress fluid, especially, refrigerant in a compressor.

As shown in FIG. 3, according to the motor of the present invention, the main coil 112 of the stator coil 112 and 114 is wound in an outer portion from a radial direction of the teeth 111 and the sub coil 112 is wound in an inner portion from the radial direction of the teeth 111. Here, a conductive material of the stator coils is configured of copper and enamel is coated on the copper.

However, as mentioned above, usage of copper as a conductive material ends up with a rise of material price and an increase of weight. To solve the problem, another material, not copper, is used as a conductive material in the present invention.

Specifically, the conductive material may be aluminum or aluminum alloy. Here, the price of aluminum or aluminum alloy is lower than that of copper and the weight of aluminum or aluminum alloy is lighter than that of copper.

Aluminum has lower conductivity than copper. The conductivity of copper is approximately 96% and the conductivity of aluminum is 60%. As a result, if the shapes or sizes of the stator and rotor are the same, there must be a capacity difference of the motor according to the stator coil formed of aluminum or copper. Thus, it is very important to minimize the above difference and not to change the shapes or sizes of the stator and the rotor at the same time.

First, if aluminum is used as a conductive material, it is possible to increase a diameter of the stator coil. As the diameter of the stator coil is larger, an electrical resistance in the coil is smaller. However, as the diameter of the stator coil is larger, the number of coil woundable around the stator should be smaller and there is a limit of the diameter increase.

In addition, if aluminum is used as a conductive material to form the stator coil, a multi-layering height of the stator may be higher to gain a wished capacity of the motor. However, there is a limit of heightening the multi-layering of the stator because of an overall height limitation of the motor.

By the way, in case of using aluminum as a conductive material, there might be a problem in a winding process. This is because aluminum has a lower ductility than copper, which means aluminum is subject to breaking or being thrust in the winding process. As a result, there might be failures in a mass production or dangerousness of disconnection.

Therefore, a conductive material of at least one of the main coil or sub coil may be aluminum or aluminum alloy. That is, the other conductive material may be copper and at least one of the main coil and sub coil may be copper claded aluminum (hereinafter, CCA). Specifically, the other conductive material may be copper. Copper is used as a conductive material to form either of the main coil and sub coil and one of aluminum, aluminum alloy and CCA is used as a conductive material to form the other.

If then, following effects may be gained.

First, compared to a case of using aluminum as a conductive material to form the stator coil, it is possible to prevent a diameter of the stator coil as well as a multi-layering height of the stator from increasing too much. In addition, it is possible to prevent coil damage. This effect may be great when using CCA as a conductive material.

According to the research of the present inventor, if only copper is used to form a stator coil, the ratio (L/D) of a multi- layering height of a stator to a diameter of a stator is approximately 0.68. If aluminum is used to form a stator coil of a motor, the ratio of a multi-layering height of a stator to a diameter of a stator is 0.78 in the same condition. That is, the multi-layering height of the stator should be increased when using only aluminum to form the stator coil, compared to when using only copper to form the stator coil.

As a result, if one of aluminum f aluminum alloy and CCA is used to form only one of the main coil and the sub coil out of the stator coil and the diameter of the stator is fixed, the multi-layering height of the stator can be reduced. In this case, the ratio (L/D) will be less than 0.78.

In the meantime, CCA is formed by coating copper on an outer layer of aluminum or aluminum alloy, such that an overall conductivity of CCA may be close to a conductivity of copper and that mechanical weakness of aluminum may be overcome. As a result, it is preferable that a conductive material of the stator coil is CCA rather than aluminum or aluminum alloy.

Here, the effect of the present invention could be greater when a rate of the main coil to the overall stator coil (in at least one of a volume, weight and raw material cost) is similar to a rate of the sub coil to the overall stator coil. For example, if a shading coil of a shading coil start motor is a sub coil, the shading coil is formed of aluminum and thus there may not be a great effect of saving material cost and reducing weight. This is because the shading coil has a substantially smaller volume or lighter weight than the main coil.

FIG. 4 is a graph illustrating capacity difference of a motor that includes a main coil 112 and a sub coil 114 formed of material having different conductivity from the main coil 112. Here, only a conductive material is different in the motor and the other conditions are identical.

As shown in FIG. 4, in a view of motor capacity, motor capacity is the greatest when copper is used for both of the main coil and the sub coil. In addition, the motor capacity is the lowest when aluminum is used for both of the main coil and the sub coil.

However, the motor capacity when using copper for the main coil and CCA for the sub coil is close to the motor capacity when using copper for both of the main coil and the sub coil.

The same result can be gained in a view of compressor efficiency when the above motor is applied to a compressor.

As shown in FIG. 4, to achieve the object of the present invention, a different conductive material is used for the main coil and the sub coil and it is preferable that either of the conducive materials is copper and that the other is CCA, which results in minimizing the increase of stator multi-layering height.

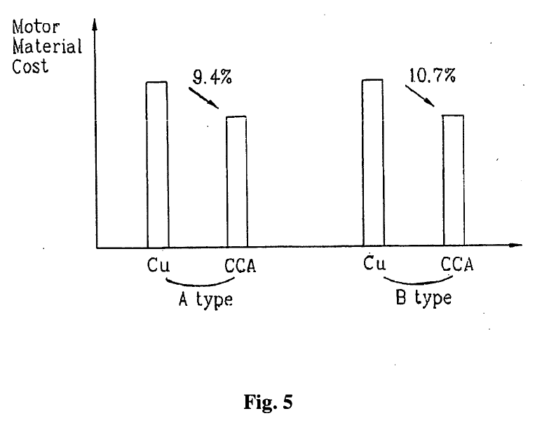

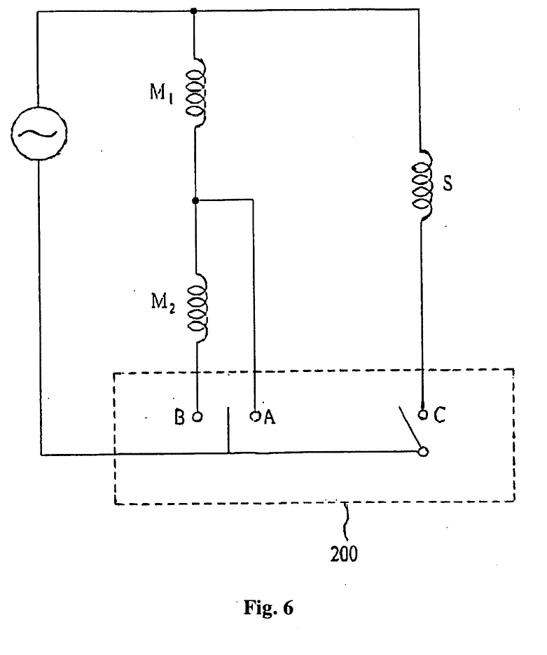

FIG. 5 is a graph illustrating material cost difference of a motor that includes the main coil 112 and the sub coil 114 formed of a material having a different conductivity from the main coil 112.

As shown in FIG. 5, material cost of two types of motors may be remarkably reduced according to the motor of the present invention.

In other words, compared to the stator formed of copper, if the main coil or the sub coil is formed of CCA, the material cost of the motor can be reduced by 9.4%˜0.7%.

This difference of material cost is remarkable based on a premise that motors are produced in large quantities.

On the other hand, it is preferable that a diameter of the main coil is different from a diameter of the sub coil to minimize the increase of the stator multi-layering, if the conductive materials of the main coil and the sub coil are different. Specifically, if copper is used for the main coil and CCA is used for the sub coil, it is preferable a diameter of the sub coil is larger than a diameter of the main coil.

When the diameter of the sub coil is larger than the diameter of the main coil, the coil number inserted and wound in the slot 113 should be smaller. As a result, it is preferable that a cross-section of the slot is large. However, there is a limit of enlarging the cross-section of the slot and thus it is preferable that only a cross-section of the slot having the sub coil wound therein is larger, not enlarging an overall cross-section of the slot. That is, it is preferable that a cross-section of a slot having the main coil wound therein is different from a cross-section of a slot having the sub coil wound therein and vice versa if CCA is used for the main coil and copper is used for the sub coil.

In addition, if the diameter is larger, it will be difficult to insert the coil in the slot and thus it is preferable that a width (A) of an opening of the slot is larger. However, as the diameter is larger, the electrical resistance of the coil is smaller and as the width of the slot is larger, a magnetic flux density is lower. As a result, it is preferable that only the width of the slot in which the coil having a larger diameter is wound is larger. In other words, it is preferable that a width of the opening of the slot in which the main coil is wound is different from a width of the opening of the slot in which the sub coil is wound.

Even though the diameter is larger, the cross-section of the slot is larger and the width of the opening of the slot is larger such that the amount of coil filled in the slot may be increased. As a result, the increase of the multi-layering height of the stator can be minimized.

It was embodied above that the conductive material of the main coil has a different conductivity from that of the sub coil and the present invention is not limited thereto. For example, the present invention may be applicable if the stator coil includes a first main coil and a second main coil.

Specifically, the main coil (M₁ and M₂) is divided and electric currents flowing to the main coil are large in a primary start operation of the motor, such that a large operational torque is generated and the time taken for a normal operation is faster. Hence, the present invention may be applicable to a motor in which electric currents flowing to the main coil are small in the normal operation to minimize power loss.

Such the motor has the same stator and rotor as the motor described above and has a different winding method.

In reference to FIG. 6, such the motor, especially, a split-phase start type motor will be explained.

As shown in FIG. 6, a main coil having a first main coil M₁ and a second main coil M₂ connected in serial is selectively connected with a single phase power terminal at a contact point B. A sub coil S connected with the main coil in parallel is selectively connected with the single phase power terminal at a contact point C.

The divided point of the first main coil M₁ and the second main coil M₂ is selectively connected with the single phase power terminal at a contact point A.

Here, the contact point A and B may be selectively on and off. The contact point of A and C may be correspondingly on and off. In other words, if the contact point A is on, the contact point B is always off. If the contact point A is off, the contact point B is always on. Also, if the contact point A is on, the contact point C is always on and if the contact point A is off, the contact point C is always off.

Here, a portion surrounded with a dotted line is corresponding to a switch box 200.

Once the power is applied in a primary start operation, the contact points A and C are on and electric currents are flowing only to the first main coil M₁ and the sub coil S. because of the primary large operational torque, the rotor is operated and rotated at a synchronous speed.

Hence, after the rotor is rotated more than a preset speed, the contact point B is on and the contact point C is off for the electric currents to flow only to the first main coil M₁ and the second main coil M₂. As a result, the currents flowing in the main coil is reduced to decrease power loss.

That is, the currents flowing to the main coil may be increased in a start operation of the motor. The currents flowing to the main coil may be reduced in a normal operation, together with cutting off electric currents to the sub coil, which makes a high efficient induction motor embodied.

As mentioned above, in the motor that includes the stator coil having the first main coil and the second main coil connected with the first main coil in serial, separating each other, the main coils may be formed of materials having different conductivity.

Here, the second main coil is selectively disconnected with the power based on operational conditions of the motor. For example, when starting the motor, the second main coil is disconnected with the power and when operating the motor normally, the second main coil is connected with the power.

The operational conditions of the motor includes operational conditions of the motor, for example, conditions relating to a test operation whether it is in a start operation or a normal operation and conditions relating to load. That is, if load applied to the motor is changed, a controller controls the divided main coils to be selectively connected with the power or controls a direction of electric currents to be changed. One of the examples is a pole change motor and two poles are changed into four poles in a kind of the pole change motor. The present invention may be applicable to such kind of the motor.

In this kind of the motor, the cross-section of the slot having the first main coil wound therein or the width of the opening of the slot may be different from the cross-section of the slot having the second main coil wound therein or the width of the opening of the slot.

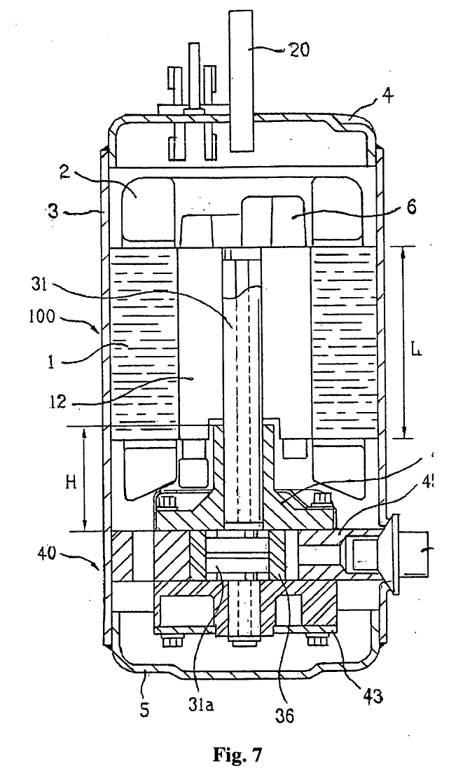

Next, in reference to FIG. 7, a compressor according to the present invention will be explained in detail. Here, the compressor may be a rotation type compressor.

As shown in FIG. 7, an exterior appearance of the compressor may be defined by an airtight container and the airtight container is configured of a cylindrical case 3, an upper cover 4 and a lower cover 5.

A refrigerant inlet 10 is formed at a predetermined portion of the case 3 and a refrigerant outlet 20 is formed near a center of the upper cover 4.

A motor unit 100 is positioned in an upper or lower portion within the airtight container and the kinds of motors mentioned above may be applicable to the motor unit 100. Here, the stator 1 is fixed to an inner wall of the cylindrical case 3.

A compression unit 40 to compress refrigerant with a power of the motor unit 100 includes a cylinder 45, bearings 42 and 43, a crankshaft 31 and a rolling piston 36.

Here, the cylinder 45 forms a predetermined space in which fluid, especially, refrigerant is compressed. An upper bearing 42 and a lower bearing 43 are secured to an upper surface and lower surface of the cylinder 45, respectively. The bearings rotatably support the crankshaft 31 and close an inner space of the cylinder 43 airtight.

The crankshaft 31 passes through a center of a rotor 12 of the motor and a center of the cylinder 45 and it is rotatable together with the rotor 12 to transmit a rotational force generated by the motor unit 100 to the compression unit 40. In addition, an eccentricity part 31a is formed in a lower portion of the crankshaft 31. The rolling piston 36 covers the eccentricity part 31a and it compresses fluid, especially, refrigerant while rotating within the cylinder.

Here, a weight center of the roiling piston 36 and a rotation center of the crankshaft 31 are not overlapped. As a result, when the rolling piston is rotated within the compressor at a high speed, there might be power imbalance that is a main cause of compressor vibration. To solve the problem, it is common that a balancer 6 is provided at an upper end of the rotor to parallel the moment. A numeral reference 2 with no description is a stator coil.

As shown in FIG. 7, the motor unit 100, especially, the motor takes much space of the compressor. As it is formed of metal mostly, the motor is quite heavy. Thus, the decrease of motor material cost and motor weight is important in the compressor, compared to other electric appliances.

For that, according to the compressor of the present invention in which the motor is operated and fluid, especially, refrigerant is compressed, the motor includes a rotor, a stator core and stator coils wound around the stator core. The stator coil includes a main coil and a sub coil formed of a material having a different conductivity from the main coil.

Here, conductive materials of the main coil and the sub coil are identical to those of the motor mentioned above. Thus, as it is possible to reduce the material cost of the motor and the compressor and to provide an economical compressor.

In the meantime, if a multi-layering height (L) of the stator is higher, there is danger of motor imbalance. To remove the dangerousness, it is preferable that a shaft direction height of the upper bearing 42 is higher. At this time, the upper bearing 42 rotatably supports the crankshaft. That is, the supporting height (H) of the upper bearing for the crankshaft may be heightened.

For that, it is preferable that the ratio (L/H) of the multi-layering height (L) of the stator to the supporting height (H) of the upper bearing supporting the crankshaft 31 is 1.6 and more and 2.0 and less.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention has an industrial applicability.

The present invention has an industrial applicability that an economical motor can be provided by reducing a material cost of coils.

Furthermore, the present invention has another industrial applicability that motors and compressors can be produced in large quantities without any change of their configurations, with the reduced material cost.

A still further, the present invention has a still further industrial applicability that a motor and a compressor having a satisfactory capacity, compared to the conventional one can be provided.

1. A motor comprising:
a rotor; and
a stator that a stator coil is wound around, the stator coil comprising:
a main coil, and
a sub coil formed of material having a different conductivity from the main coil.

2. The motor of claim 1, wherein a conductive material of at least one of the main coil and the sub coil is configured of aluminum of aluminum alloy.

3. The motor of claim 1, wherein a conductive material of at least one of the main coil and the sub coil is configured of copper.

4. The motor of claim 1, wherein a conductive material of at least one of the main coil and the sub coil is configured of aluminum alloy or copper claded aluminum.

5. The motor of claim 1, wherein a diameter of the main coil is different from a diameter of the sub coil.

6. The motor of claim 1, wherein a conductive material of the main coil is configured of copper and a conductive material of the sub coil is configured of aluminum alloy or copper claded aluminum.

7. The motor of claim 6, wherein a diameter of the sub coil is substantially larger than a diameter of the main coil.

8. The motor of claim 7, wherein a width of an opening of a stator slot having the sub coil wound in is substantially larger than a width of an opening of a stator slot having the main coil wound in.

9. The motor of claim 7, wherein a cross-section of a stator slot having the sub coil wound in is identical to or larger than a cross-section of a stator slot having the main coil wound in.

10. The motor of claim 1, wherein a ratio (L/D) of a multi-layering height of the stator to a diameter of the stator is more than 0.62 and the ratio is 0.78 and less.

11. A motor comprising:
a rotor; and
a stator that a stator coil is wound around, the stator coil comprising,
a first main coil, and
a second main coil connected with the first main coil in serial and separated from the first main coil, the second main coil formed of a material having a different conductivity from the first main coil.

12. The motor of claim 11, wherein the second main coil is selectively disconnected from the power or a current direction of the second main coil is changed, based on operational conditions of the motor.

13. The motor of claim 12, wherein the stator coil further comprises a sub coil connected with the first main coil and the second main coil in parallel with respect to the power.

14. The motor of claim 12, wherein a conductive material of at least one of the first main coil and the second main coil is configured of aluminum or aluminum alloy.

15. The motor of claim 12, wherein a conductive material of at least one of the first main coil and the second main coil is configured of copper.

16. The motor of claim 12, wherein a conductive material of at least one of the first main coil and the second main coil is configured of aluminum alloy or copper claded aluminum.

17. A compressor including a motor operated to compress fluid, wherein the motor comprises:
a rotor; and
a stator that a stator coil is wound around, the stator coil comprising a main coil, and
a sub coil formed of material having a different conductivity from the main coil.

18. The motor of claim 17, wherein a diameter of the main coil is different from a diameter of the sub coil.

19. The motor of claim 18, wherein a conductive material of the main coil is configured of copper and a conductive material of the sub coil is configured of aluminum alloy or copper claded aluminum, further wherein the compressor is a rotation-type compressor.

20. The motor of claim 19, wherein a ratio (L/D) of a multi-layering height of the stator to a diameter of the stator is more than 0.62, and the ratio is 0.78 and less.

21. The motor of claim 19, wherein a diameter of the sub coil is substantially larger than a diameter of the main coil.

22. The motor of claim 21, wherein a width of a slot opening of a stator that the sub coil is wound around is substantially larger than a width of a slot opening of a stator that the main coil is wound around.

23. The motor of claim 21, wherein a cross-section of a slot of a stator that the sub coil is wound around is identical to or larger than a cross-section of a slot of a stator that the main coil is wound around.

24. The compressor of claim 18, comprising:
a crankshaft rotatable with the rotor to transmit a rotational force to a compression device unit; and
an upper bearing to rotatably support a lower portion of the crankshaft,
wherein a ratio (L/H) of a multi-layering height of a stator to a supporting height of the upper bearing that supports the crankshaft is 1.6 more and the radio is 2.0 and less.
The compressor of claim 18, wherein a conductive material of the main coil is configured of copper and a conductive material of the sub coil is configured of aluminum alloy or copper claded aluminum, further wherein the compressor is a reciprocation-type compressor.
